(19) United States
(12) Patent Application Publication
(10) Pub. No.: US 2012/0040832 A1
(43) Pub. Date: Feb. 16, 2012

(54) HERBICIDAL COMPOSITION COMPRISING AN AMINOPHOSPHATE OR AMINOPHOSPHONATE SALT AND AN N-ALKYL-PYRROLIDONE SOLVENT

(75) Inventors: Poay huang Chuah, Singapore (SG); Massimo Guglieri, Nector Otto (MC)

(73) Assignee: Rhodia Operations, Aubervilliers (FR)

(21) Appl. No.: 13/061,111

(22) PCT Filed: Aug. 25, 2009
(86) PCT No.: PCT/EP2009/060913

§ 371 Date: Nov. 1, 2011

Related U.S. Application Data
(60) Provisional application No. 61/093,125, filed on Aug. 29, 2008.

(51) Int. Cl. A01N 57/20; A01P 13/00; A01N 25/02

(52) U.S. Cl. 504/206; 504/362

(57) ABSTRACT

The present invention relates to herbicidal compositions comprising an aminophosphate or aminophosphonate salt, for example to herbicidal compositions comprising an aminophosphate or aminophosphonate potassium salt. Preferred compositions of the invention have a high amount and the aminophosphate or aminophosphonate salt. The invention also relates to compositions of matter (or blend) that are especially useful ingredients for preparing the compositions comprising the aminophosphate or aminophosphonate salt. In particular, these ingredients are a surfactant such as an amine oxide surfactant, and an organic solvent comprising an N-alkylpyrrolidone wherein the alkyl group comprises at least 2 carbon atoms.

### BACKGROUND OF THE INVENTION

The present invention relates to herbicidal compositions comprising an aminophosphate or aminophosphonate salt, for example to herbicidal compositions comprising an aminophosphate or aminophosphonate potassium salt. Preferred compositions of the invention have a high amount and the aminophosphate or aminophosphonate salt. The invention also relates to compositions of matter (or blend) that are especially useful ingredients for preparing the compositions comprising the aminophosphate or aminophosphonate salt.

Among various presentations of compositions comprising glyphosate, concentrated liquid compositions that can be diluted by the end-user (for example, a farmer) are of interest. Usually, the higher the glyphosate concentration is the better it is, because the end-user can set the use concentration (amount of active applied to the field) by adjusting the dilution rate, and can avoid handling much product (the higher the concentration is the lower the weight is for example). Higher concentrations can also save packaging and/or disposal costs thereof.

Concentrated compositions can comprise a high amount of glyphosate salt, water, and at least one surfactant compound that can be useful as a formulation aid (dispersion, dissolution and/or stability of the glyphosate in water), and/or as a biological activator (for example increasing the efficacy the glyphosate, for example by encouraging wetting of a weed to be eliminated, or by encouraging penetration of the glyphosate into the weed). The amount of glyphosate, the surfactant(s), the amount thereof, and possible further ingredients might have also an effect onto the rheological properties of the formulation (for example viscosity, or ability to be spread), as such or upon dilution. The rheological properties of the formulation as such or upon dilution are important for handling and spreading purpose.

Where the concentration of glyphosate is high, crystallization and/or precipitation is to be avoided. Crystallization can occur at different temperatures, at different glyphosate concentrations, or upon diluting with water. The crystallization and/or precipitation is characterized by formation of small solid particles comprising glyphosate. These small particles can have the bad impact of filters clogging, nozzles clogging, creating unnecessary hazardous waste problems to dispose off the crystals, loss of activity (bioefficacy), and/or bad repartition of the active on the field.

There is a need for new compositions that address at least one of the following:
lower cost, by using lower cost ingredients (the aminophosphate or aminophosphonate salts and/or the surfactants)
better ecotoxic profile (especially lowering amounts of fatty ethoxyltes such as fatty amine ethoxyles), and/or better perception of the ecotoxic profile,
better safety profile (including reprotoxicity issues), and/or better perception thereof,
easier use and/or or lower cost use, for example by allowing less packaging and/or less transportation means, for example by concentrating,
easier to handle, for example by having a favorable viscosity and/or by avoiding crystallization and/or precipitation. (Crystallization and/or precipitation can occur at different temperatures, at different glyphosate concentrations, or when diluting with water. The crystallization is characterized by formation of small solid particles comprising glyphosate. These small particles can have the bad impact of filters clogging, nozzles clogging, creating unnecessary hazardous waste problems to dispose off the crystals, loss of activity (bioefficacy), and/or bad repartition of the active on the field).

Document WO 2007/054540 describes compositions comprising an aminophosphate or aminophosphonate salt, a surfactant, and N-methyl-pyrrolidone. The document discloses the N-methyl-pyrrolidone can be useful for lowering the viscosity. This solvent is however perceived dangerous (including reprotoxicity issues) and/or ecotoxic. There is a need for different compositions, having different solvents and/or lower amounts of solvent, while presenting suitable viscosities.

### BRIEF SUMMARY OF THE INVENTION

The invention addresses at least one of the needs above, or a combination thereof. Thus the invention relates to an aqueous herbicidal composition comprising:
an aminophosphate or aminophosphinate salt,
a surfactant, and
an organic solvent comprising an N-alkylpyrrolidone wherein the alkyl group comprises at least 2 carbon atoms.

This invention also relates to a composition of matter (or “blend”) comprising at least 50% by weight, preferably at least 75% by weight, preferably at least 90% by weight, of a mixture of the following compounds:
optionally water,
an amine oxide compound, typically an alkyl dimethyl amine oxide compound of formula (I) below or an alkylamidoalkyl amine oxide compound of formula (II) below:

R¹—N⁺(CH₃)₂—O⁻ (I)

R¹—CONR³—R⁴—N⁺(CH₃)₂—O⁻ (II)

wherein
R¹ is a linear or branched, optionally cyclic, alkyl group having an average number of carbon atoms of from 8 to 30, preferably of from 10 to 18, and
R⁴ is a divalent C₁-C₆ alkyl group, preferably a —(CH₂)₃— group, and
a solvent comprising an N-alkylpyrrolidone wherein the alkyl group comprises at least 2 carbon atoms.

Unexpectedly the N-alkylpyrrolidone solvents comprising at least 2 carbon atoms allow:
lowering the viscosity at constant amount, compared to solvents of the prior art, and/or
lowering the amount (compared to solvents of the prior art) at constant viscosity, thus reducing potential impact on safety and/or environment (or at least the perception of such an impact)
leaving room in the composition to achieve higher concentrations.

### DETAILED DESCRIPTION OF THE INVENTION

### Definitions

In the present specification, unless otherwise provided, the amounts of aminophosphate or aminophosphonate salt, preferably a glyphosate or gluphosinate salt are expressed as acid equivalents (“ae”).

In the present specification, unless otherwise provided, the amounts of surfactants or compositions of matter are amounts “as is”, as opposed to amounts as active matter, dry amounts, or the like.

The ingredients of the composition are described below.

### Aminophosphate or Aminophosphonate Salt

Aminophosphate or aminophosphonate salts are known by the one skilled in the art. Preferred salts are glyphosate or gluphosinate salts. Glyphosate refers to N-(phosphonomethyl)glycine. Gluphosinate refers to 4-[hydroxy(methyl)phosphinoyl]-DL-homoalanine.

Useful salts include:
sodium (Na) salts;
potassium (K) salts;
ammonium salts having N(R)₄⁺ cations wherein R groups, identical or different, represent a hydrogen atom or a linear or non linear, saturated or unsaturated C₁-C₆ hydrocarbon group optionally substituted by a hydroxyl group, for example isopropylamine salts;
sulphonium salts; said salts being present alone or in a combination.
   Ammonium salts that can in particular be cited include salts obtained from secondary or primary amines such as isopropylamine (IPA), dimethylamine, diamines such as ethylenediamine, or alkanolamines such as monoethanolamine (MEA). Trimethylsulphonium is a suitable sulphonium salt,
mixtures or associations thereof.

Preferred glyphosate salts that can be cited are isopropylamine (IPA—or “isopropylammonium”) salt, monoethanolamine (MEA) salt, trimethylsulphonium salt, potassium salt, ammonium salt, and mixtures or associations thereof, for example as taught in documents WO01/26469 (Nufarm) and WO03/013241 (Nufarm). Advantageously the aminophosphate or aminophosphonate salt comprises at least 10% by weight, preferably at least 50%, preferably at least 90%, of isopropylammonium aminophosphate or aminophosphonate salt, such as isopropylammonium glyphosate, or of potassium aminophosphate or aminophosphonate salt, such as potassium glyphosate salt.

Particularly useful salts are potassium glyphosate, isopropyl ammonium glyphosate, or ammonium gluphosinate.

The salt can be formed upon preparation of the composition by adding whole or a part of the total aminophosphate or aminophosphonate in acid form, and neutralizing to form the salt with the corresponding amount of base (such as KOH, amine etc). If only a part has been introduced and prepared, then the remaining can be added wholly or as parts.

### Surfactant

Various surfactants can be comprised in the composition. Useful surfactants are sometimes referred to as bioactivators. Such compounds are known by the one skilled in the art and many are described in the literature. It is mentioned that surfactants can be provided in the form of a solution having 10-60%, for example 15-50%, typically 25-35%, by weight of solids.

Suitable surfactants, especially when the salt is a potassium salt, include amine oxide surfactants. These include the class of alkylamidoalkyl amine oxides, such as alkylamidoalkyl dimethyl amine oxide surfactants having the compound of formula (II) below, and the class of alkylamine oxides such as alkyl dimethyl amine oxide surfactants having the compound of formula (I) below:

R¹—N⁺(CH₃)₂—O⁻ (I)

R¹—CONR³—R⁴—N⁺(CH₃)₂—O⁻ (II)

wherein
R¹ is a linear or branched, optionally cyclic, alkyl group having an average number of carbon atoms of from 8 to 30, preferably of from 10 to 18, and
R⁴ is a divalent C₁-C₆ alkyl group, preferably a —(CH₂)₃— group.
   Such surfactants are known, and are available on the market.

The R¹ group is usually actually a mixture of different groups having different numbers of carbon atoms, being linear or branched, optionally cyclic, and optionally having some insaturations. These mixtures come from the reagents used to prepare them, which are actually distillation cuts and/or have a natural origin. In the present specification the number of carbon atoms in the R¹ group refers to the number of carbon atoms of the two most represented species. Preferably R¹ has an average number of carbon atoms of from 10 to 18. Advantageously R¹ is an alkyl group comprising at least 50% by weight of a lauryl or myristyl group, preferably a lauryl group.

### Other Surfactants Include for Example:

an ethoxylated fatty amine, a fatty amine,
an ether carboxylate,
an acid or non acid mono- and di-ester phosphate, optionally polyalkoxylated,
an alkylmonoglycoside or alkylpolyglycoside, advantageously octylglycoside, an octylpolyclycoside, decylglycoside, a decylpolyglycoside, or a mixture thereof
bétaïnes (alkyldimethylbétaines, or alkylamidoalkyldimethylbetaines, such as alkylamidopropyldimethylbetaines, where the alkyl is R group as describes above), or
mixtures thereof.

In a particular embodiment, the composition is substantially free (less than 10% by weight of the total surfactant amount, preferably less than 1%, preferably none) of betaines.

The fatty amines or ethoxylated fatty amines can comprise at least one hydrocarbon group containing 2 to 24 carbon atoms, optionally polyalkoxylated.

The fatty amines or ethoxylated fatty amines can more particularly be selected from amines comprising at least one linear or branched, saturated or unsaturated group containing 2 to 24 carbon atoms, preferably 8 to 18 carbon atoms, optionally comprising 2 to 30 oxyethylene groups, or a mixture of a plurality thereof. Examples include ethoxylated tallow amines.

The fatty amines or ethoxylated fatty amines can be selected from ethoxylated fatty amines comprising at least one linear or branched, saturated or unsaturated groups containing 6 to 24 carbon atoms, preferably 8 to 20 carbon atoms, comprising 2 to 30 oxyethylene groups, or a mixture of a plurality thereof. Examples include the compounds having the following formula:

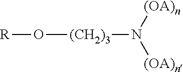

wherein R represents a linear or branched, saturated or unsaturated hydrocarbon group containing 6 to 24 carbon atoms, preferably 8 to 20 carbon atoms; OA represents an oxypropylene group; and n, n′, which may or may not be identical, represent a mean number in the range 1 to 30.

Examples of such amines that can be cited are amines derived from copra and containing 5 oxyethylene (OE) motifs, oleic amines containing 5 OE, amines derived from tallow containing 5-20 OE, for example 10, compounds corresponding to the above formula, in which R is an alkyl group containing 12 to 15 carbon atoms, the number of

OE motifs being in the range 20 to 30.

The amount of fatty amines or ethoxylated fatty amines can be of from 0 (none) to 120 g/l of the composition, preferably of from 0 (none) to 60 g/l.

The ether carboxylate has preferably formula R(OCH₂CH₂)ₙOCH₂CO₂⁻, wherein R is a linear or branched alkyl, alkenyl, alkylphenyl or polypropyleneoxy group having from 6 to 20, for example 8 to 14, aliphatic carbon atoms and n is of from 1 to 30, preferably of from 2 to 20. The ether carboxylate has preferably a counter ion being ammonium or potassium, or obtained from an amine or alkanolamine having up to 6 carbon atoms.

The acid or non acid mono- and di-ester phosphate, optionally polyalkoxylated is selected from acid or non acid phosphate mono- or di-esters, optionally polyalkoxylated, with the formula below:

(AO)₃₋ₘP(=O)(OM)ₘ

wherein:
A, identical or different, represents a group R′¹—O(CH₂—CHR′²—O)ₙ wherein:
R′¹, identical or different, represents a linear or non linear, saturated or unsaturated C₆-C₂₀ hydrocarbon group, preferably C₈-C₁₈;
R′², identical or different, represents a hydrogen atom or a methyl or ethyl group, preferably a hydrogen atom;
n is a mean number of motifs in the range 0 to 10, preferably in the range 2 to 10;
M, identical or different, represents a hydrogen atom, an alkali or alkaline-earth metal, a N(R³)₄⁺ type radical wherein R³, identical or different, represents a hydrogen atom or a linear or non linear, saturated or unsaturated C₁-C₆ hydrocarbon group optionally substituted with a hydroxyl group;
m is a whole or average number in the range 1 to 2.

The acid or non acid mono- and di-ester phosphate, optionally polyalkoxylated can be in the form of a monoester, a diester, or a mixture of these two esters.

The amount of acid or non acid mono- and di-ester phosphate, optionally polyalkoxylated can be of from 0 (none) to 120 g/l of the composition.

### Organic Solvent

The solvent comprises an N-alkylpyrrolidone wherein the alkyl group comprises at least 2 carbon atoms. The solvent can be a mixture of solvents comprising the N-alkylpyrrolidone and other solvents. Other solvents are liquids different from water. Preferably the N-alkylpyrrolidone constitutes at least 50% by weight, preferably at least 75%, preferably at least 95%, preferably all of the solvent(s).

The alkyl group in the N-alkylpyrrolidone is advantageously ethyl, n-propyl, isopropyl, n-butyl, isobutyle, tertbutyl, hexyl, cyclohexyl, n-octyl, isooctyl, ethylhexyl, dodecyl, or a mixture thereof.

### Examples of Other Solvents Include:

N-methyl-pyrrolidone (NMP, can be further identified for example with CAS number 872-50-4)
diester solvents,
propylene carbonate,
acetophenone,
ethylene glycol butyl ether,
diethylene glycol butyl ether,
methoxy methyl butanol,
propylene glycol methyl ether,
dipropylene glycol methyl ether,
gamma-butyrolactone,
dimethyl formamide (DMF),
furfuryl alcohol,
tetrahydrofuryl alcohol,
neopentyl glycol,
hexadiols,
hexylene glycol,
glycol ether amines,
ethylene glycol monoacetate, or
a mixture or association thereof.
   Examples of Diester Solvents have the Following Formula:

R¹OOC—(CH₂)ₙ—COOR²,

wherein:
R¹ and R², identical or different, are C₁-C₁₀, preferably C₁-C₆, linear or branched, alkyl, aryl, alkaryl or arylalkyl groups, and
n is an average number of from 2 to 4.
   The diester solvent can be a dialkyl, diaryl, dialkaryl or dialkylaryl adipate, such as for example diisobutyl adipate.
   As n is an average number, the diester co-solvent can be a mixture of several compounds having different numbers of —CH₂— groups.
   The diester solvent can be a mixture of adipate diesters (n=4), glutarate diesters (n=3), and succinate diesters (n=2).
   The diester solvent is preferably a mixture of diisobutyl adipate, diisobutyl glutarate, and diisobutyl succinate, for example a mixture comprising:
from 59 to 67 parts by weight of diisobutyl glutarate,
from 20 to 28 parts by weight of diisobutyl succinate, and
from 9 to 7 parts by weight of diisobutyl adipate.
   Examples of useful diester solvents include Rhodiasolv DIB®, marketed by Rhodia.
   The diester solvents described above are considered as green solvent having a low Volatile Organic Compound behavior and/or a low toxicity.
   Other interesting diester solvents include dimethyl adipate and mixutres of dimethyl adipate, dimethyl glutarate and dimethyl succinate, for example Rhodiasolve RPDE®, marketed by Rhodia.

### Further Ingredients

The herbicidal composition can comprise further ingredients, such as:
surfactants different from the alkyldimethylamine oxide,
humectants,
anti-foaming agents,
solvents, preferably water miscible solvent, preferably polar solvents, or
deposition control agents such as anti-rebound or anti-drift agents, optionally added afterward.
   In a particular embodiment the composition is substantially free (less than 10% by weight of the total composition, preferably less than 1%, preferably none) of a humectant selected from polyhydric alcohols, polysaccharide humectants, and mixtures thereof.

Humectants that can be used are for example polyhydric alcohols or polysaccharide humectants. Polyhydric alcohols are compounds having at least two alcohol functional groups per molecule, including for example, diols, such as, ethylene glycol, propylene glycol, polyethylene glycol, and triols such as glycerol. A preferred humectant is glycerol. Suitable polysaccharide humectants include, for example, alkyl polysaccharides, pentoses, high fructose corn syrup, sorbitol and molasses. In one embodiment, the polysaccharide humectant comprises high fructose corn syrup.

The one skilled in the art knows further ingredients that can be used for managing some properties or features of the composition and/or for adding benefits.

The Formulations can for Example Comprise for Example:
organopolysiloxanes antifoaming agent;
humectants
thickening agents such as xanthan gum type polysaccharides, alginates, carboxylated or hydroxylated methylcelluloses, synthetic macromolecules of the polyacrylate, polymaleate, polyvinylpyrrolidone, polyethylene glycol or polyvinyl alcohol type, or of the inorganic type such as bentonites.
auxiliary additives such as antioxidants, anti-UV agents, colorants, etc.
solvent such as an alcohol, for example isopropanol, typically up to 15% by weight.

The amount of these additives listed above is normally less than 10% by weight, preferably 1% by weight or less, advantageously 0.1% by weight or less compared with the composition weight.

### Composition of Matter (Blend)

The composition of matter (or “blend”) comprises at least 50% by weight, preferably at least 75% by weight, preferably at least 90% by weight, of a mixture of the following compounds:
optionally water, and
an amine oxide compound, preferably being an alkyl dimethyl amine oxide of formula (I) below or an alkylamidoalkyl amine oxide of formula (II) below:

R¹—N⁺(CH₃)₂—O⁻ (I)

R¹—CONR³—R⁴—N⁺(CH₃)₂—O⁻ (II)

wherein
R¹ is a linear or branched, optionally cyclic, alkyl group having an average number of carbon atoms of from 8 to 30, preferably of from 10 to 18, and
R⁴ is a divalent C₁-C₆ alkyl group, preferably a—(CH₂)₃— group, and
a solvent comprising an N-alkylpyrrolidone wherein the alkyl group comprises at least 2 carbon atoms.

### Preferred Amine Oxide Surfactants and Preferred Solvents are Described Above.

The ratio by weight between the amount of solvent and the sum of the amounts of the amine oxide compound and the amount of optional water (the sum is typically an amine oxide surfactant in the form of a solution, as is) is preferably of from 0.025 to 0.20, preferably from 0.03 to 0.15, preferably from 0.04 to 0.08. The ratio by weight between the amount of solvent and the amount of amine oxide compound (as active or solid) is preferably of from 0.083 to 0.66, preferably from 0.1 to 0.5, preferably from 0.13 to 0.26.

The composition of matter can also comprise one or several of the further ingredients above, especially an anti-foaming agent.

It is mentioned that the composition of matter (or “blend”) can be provided in the form of a solution having 10-75%, preferably 10-60%, for example 15-50%, typically 25-35% by weight of solids.

According to one embodiment the mixture of the composition of matter further comprises further a humectant such as a polyhydric alcohol, preferably glycerol, or a polysaccharide humectant. Examples of such humectants are given above. The ratio by weight between the amount of humectant and the sum of the amounts of the amine oxide compound and the amount of optional water can be for example of from 0.01 to 100, for example of from 0.1 to 10, for example of from 0.1 to 1.

### Process for Preparing the Herbicidal Composition.

The compositions of the invention can be prepared by mixing their different constituents with moderate stirring.

This operation preferably takes place at a temperature in the range 15° C. to 60° C., preferably at a temperature close to ambient temperature (15-30° C.).

The surfactant is preferably only added once the other constituents have been mixed. Alternatively the surfactant or a part thereof is added during neutralization of the aminophophate or aminophosphonate. The remaining part can be added afterwards.

### Composition: Concentrations and Other Parameters

The composition advantageously comprises from 1 g/L to 50 g/L of the solvent, preferably from 5 g/L to 25 g/L of the solvent, preferably from 6 g/L to 14 g/L of the solvent, for example from 6 g/L to less than 10 g/L or from 10 g/L to less than 14 g/L.

In a preferred embodiment the composition has:
aminophosphate or aminophosphonate salt being glyphosate potassium salt, and
N-ethyl-pyrrolidone solvent.

Advantageously the composition comprises:
at least 100 g/L of the aminophosphate or aminophosphonate salt
at least 50 g/L of the surfactant, and
at least 0.5 g/L of the solvent.

More advantageously the composition comprises:
at least 360 g/L of the aminophosphate or aminophosphonate salt
at least 80 g/L, preferably at least 100 g/L of the surfactant, and
at least 1 g/L of the solvent.

Particularly interesting compositions comprise:
at least 500 g/L of glyphosate potassium salt,
from 100 to 160 g/L, preferably from 120 to 150 g/L of the amine oxide surfactant, and
from 1 to 50 g/L of the solvent, preferably from 5 g/L to 25 g/L of the solvent, preferably from 6 g/L to 14 g/L of the solvent, for example from 6 to less than 10 g/L or from 10 to less than 14 g/L.

It is mentioned that the above amount of surfactant ranges, concern amounts of surfactant as is that might comprise water (surfactants can be provided in the form of a solution having 10-60%, for example 15-50%, typically 25-35%, by weight of solids).

Preferably, especially at high potassium glyphosate loads, the ratio by weight between the solvent and the alkyl dimethyl amine oxide surfactant is preferably of from 0.025 to 0.20, preferably from 0.03 to 0.15, preferably from 0.04 to 0.08.

In a preferred embodiment the composition does not form anisotropic aggregates and/or liquid crystals after application on foliage. In a preferred embodiment the composition does not form transcuticular channels in leaves and/or epicuticular channels on leaves. In those embodiments efficacy can remain surprisingly high.

### Downstream Use

The herbicidal composition of the invention can be thus used to treat plants, normally after diluting with water. The diluted composition can be applied onto a field by any appropriate means.

The dilution, and the application onto the field, can be for example such that the amount of aminophosphate or aminophosphonate salt, preferably glyphosate potassium salt, is of from 500 g acid equivalent/ha to 1500 g acid equivalent/ha, typically from 300 to 1200 g/ha.

### Some Details or Advantages of the Invention Will Appear in the Non-Imitative Examples Below.

### EXAMPLES

### Examples 1-3

The compositions in Table I below are prepared are prepared (C stands for comparative, ae stands for acid equivalent).

Samples of 100 mL each are prepared in volume flasks, individually neutralized. Tap water is used.

TABLE I

| Example | 1C | 2 | 3C |
|---|---|---|---|
| Glyphosate Potassium¹⁾ | 540ae | 540ae | 540ae |
| (g/L) | | | |
| Surfactant 1²⁾ (g/L) | 146 | 146 | 146 |
| NMP³⁾ (g/L) | 14 | | |
| NEP⁴⁾ (g/L) | | 14 | |
| HEP⁵⁾ | | | 14 |
| Water | To volume | To volume | To volume |
| Appearance (Room | Clear | Clear | Clear Pale |
| Temperature) | colourless | colourless | Yellow |
| | liquid | liquid | liquid |
| Specific Gravity (20° C.) | 1.361 | 1.360 | 1.361 |
| pH (7% in D.I. water) | 4.68 | 4.75 | 4.74 |
| Viscosity⁶⁾ | 23.9° C.: 100 | 23.5° C.: 60 | 24° C.: 350 |
| 20 rpm | 2.2° C.: 200 | 2.1° C.: 150 | 3° C.: 800 |
| Viscosity⁶⁾ | 23.9° C.: 120 | 23.5° C.: 80 | 24° C.: 376 |
| 50 rpm | 2.2° C.: 224 | 2.1° C.: 160 | 3° C.: 820 |
| Storage Stability | Pass | Pass | Pass |
| (Physical stability) | | | |
| after 2 weeks at: | | | |
| 54° C. (unseeded) | | | |
| Storage Stability | Pass | Pass | Pass |
| (Physical stability) | | | |
| after 2 weeks at: | | | |
| 0-3° C. (unseeded) | | | |

¹⁾Provided as 568.6 g/L mixture of Glyphosate 95% acid (white powder) and KOH 50%
²⁾Lauryldimethylamine oxide provided as a 30 wt % solution - amount of solution as is.
³⁾N-methyl-pyrrolidone: M-pyrol Micropure Ultra II, ISP technologies - Viscosity (spindle 1, 20 rpm) at 20 rpm is of 5.5 cP.
⁴⁾N-ethyl-pyrrolidone: supplied by BASF - Viscosity (spindle 1, 20 rpm) at 20 rpm is of 5.5 cP.
⁵⁾N-hydroxyethyl-pyrrolidone: supplied by Sigma Aldrich - Viscosity (spindle 1, 20 rpm) at 20 rpm is of about 120 cP.
⁶⁾Brookfield RVT, Temperature indicated, spindle 4, 100 mL sample, expressed as cP, measured on 100 mL in a 120 mL glass of inner diameter of about 4.7 cm.

### Example 4

The composition of matter (“Blend”) below is prepared:

| Example | 4 |
|---|---|
| Surfactant 1²⁾ | 146 g |
| NEP⁴⁾ | 14 g |

### Example 5

The composition below is prepared:

| Example | 5 |
|---|---|
| Glyphosate Potassium ¹⁾ (g/L) | 540ae |
| Blend of example 4 (g/L) | 160 |
| Water | To volume |
| Appearance (Room | Clear colourless liquid |
| Temperature) | |
| Specific Gravity (20° C.) | 1.357 |
| pH (7% in D.I. water) | 4.76 |
| Viscosity ⁶⁾ | 23° C.: 60 |
| 20 rpm | 2.9° C.: 150 |
| Viscosity ⁶⁾ | 23° C.: 80 |
| 50 rpm | 2.9° C.: 160 |
| Storage Stability (Physical | Pass |
| stability) after 2 weeks at: | |
| 54° C. (unseeded) | |
| Storage Stability (Physical | Pass |
| stability) after 2 weeks at: | |
| 0-3° C. (unseeded) | |

1-11. (canceled)

12. An aqueous herbicidal composition comprising:
an aminophosphate or aminophosphinate salt,
a surfactant, and
an organic solvent comprising an N-alkylpyrrolidone,
wherein the alkyl group comprises at least two carbon atoms.

13. The composition of claim 12, wherein the alkyl group comprises ethyl, n-propyl, isopropyl, n-butyl, isobutyl, tertbutyl, hexyl, cyclohexyl, n-octyl, isooctyl, ethylhexyl, dodecyl, or a mixture thereof.

14. The composition of claim 12, wherein:
the aminophosphate or aminophosphonate comprises glyphosate, and/or
the salt comprises a potassium salt.

15. The composition of claim 14, wherein the aminophosphate or aminophosphonate salt comprises potassium glyphosate.

16. The composition of claim 12, wherein the surfactant comprises an amine oxide surfactant.

17. The composition of claim 16, wherein amine oxide surfactant comprises an alkyl dimethyl amine oxide of formula:
R¹—N⁺(CH₃)₂—O⁻
or an alkylamidoamine oxide surfactant of formula:
R¹—CONR³R⁴—N⁺(CH₃)₂—O⁻
wherein:
R¹ comprises a linear or branched, optionally cyclic, alkyl group having an average number of carbon atoms ranging from 8 to 30, and
R⁴ comprises a divalent C₁-C₆ alkyl group.

18. The composition of claim 12, wherein said composition comprises:
at least 360 g/L of the aminophosphate or aminophosphonate salt
at least 80 g/L of the surfactant, and
at least 1 g/L of the solvent.

19. The composition of claim 12, wherein the amount of solvent ranges from 1 g/L to 50 g/L of the solvent.

20. The composition of claim 19, wherein the amount of solvent ranges from 5 g/L to 25 g/L.

21. The composition of claim 20, wherein the amount of solvent ranges from 6 g/L to 14 g/L.

22. The composition of claim 21, wherein the amount of solvent ranges from 6 g/L to less than 10 g/L.

23. The composition of claim 21, wherein the amount of solvent ranges from 10g/L to less than 14 g/L.

24. The composition of claim 12, wherein:
the aminophosphate or aminophosphinate salt comprises a glyphosate potassium salt, and
the solvent comprises N-ethylpyrrolidone.

25. The composition of claim 12, wherein said composition comprises:
at least 500 g/L of glyphosate potassium salt,
from 100 to 160 g/L, of an amine oxide surfactant, and
from 1 to 50 g/L of the solvent.

26. The composition of claim 12, further comprising:
an anti-foaming agent,
a deposition control agent, or
mixtures or associations thereof.

27. A composition comprising at least 50% by weight of a mixture comprising:
an amine oxide;
a solvent comprising an N-alkylpyrrolidone,
wherein the alkyl group comprises at least two carbon atoms; and
optionally, water.

28. The composition of claim 27, wherein the amine oxide comprises an alkyl dimethyl amine oxide of formula:
R¹—N⁺(CH₃)₂—O⁻
or an alkylamidoalkyl amine oxide of formula:
R¹—CONR³R⁴—N⁺(CH₃)₂—O⁻
wherein:
R¹ comprises a linear or branched, optionally cyclic, alkyl group having an average number of carbon atoms ranging from 8 to 30, and
R⁴ comprises a divalent C₁-C₆ alkyl group.

29. The composition of claim 27, wherein the mixture further comprises a humectant.
